(19) United States
(12) Patent Application Publication
(10) Pub. No.: US 2018/0172469 A1
(43) Pub. Date: Jun. 21, 2018

(54) OUTPUTTING OF A MANOEUVRE INSTRUCTION BY MEANS OF A ROUTE GUIDANCE DEVICE

(71) Applicant: Preh Car Connect GmbH, Dresden (DE)

(72) Inventors: Thomas OBENAUS, Dresden (DE); Torsten TRENTZSCH, Dresden (DE); Benno SENGER, Dresden (DE)

(73) Assignee: Preh Car Connect GmbH, Dresden (DE)

(21) Appl. No.: 15/848,857

(22) Filed: Dec. 20, 2017

(30) Foreign Application Priority Data
Dec. 21, 2016 (DE) 10 2016 015 696.1

(51) Int. Cl. G01C 21/36

(52) U.S. Cl. CPC G01C 21/3655; G01C 21/3658; G01C 21/3691

(57) ABSTRACT

The present disclosure relates to a method for outputting a manoeuvre instruction by a route guidance device, the method including: determining a route for a movable object; determining a current position of the object on the route; determining a manoeuvre position arranged on the route where the object is to execute a manoeuvre to follow the route and, depending on a number of paths (n) of paths, which are arranged between the position of the object and the manoeuvre position alongside the route, and/or a traffic density (d) on the route between the position of the object and the manoeuvre position; determining an output position which is arranged between the position of the object and the manoeuvre position on the route; generating a manoeuvre instruction attributed to the output position; outputting a manoeuvre instruction to a user of the route guidance device when the object reaches the output position.

This application claims priority to the German Application No. 10 2016 015 696.1, filed Dec. 21, 2016, now pending, the contents of which are hereby incorporated by reference.

The present disclosure relates to a method for outputting a manoeuvre instruction by means of a route guidance device and a route guidance device for executing the method.

A route guidance device is able to compute a route leading from a current position of the route guidance device to a target position. In most cases, the position of the route guidance device is determined by the use of a global satellite route guidance system, such as by the use of NAVSTAR GPS, GLONASS, BEIDOU, or GALLILEO. In general, the target position is derived from a target that a user indicates to the route guidance device by means of a control unit of the route guidance device. Alternatively, the target position can also be determined based upon historic data by means of an estimation, for example based upon routes already covered.

A route can be provided by computing the route using a processing unit of the route guidance device. Landscape data are used in order to compute such route, in general, such data being stored in a non-volatile storage unit of the route guidance device, for example on a CD ROM, on a hard disk, or in a flash memory. Such landscape data represent geographic objects and information attributed to these, such as streets, ways, junctions, squares, railroads, waterways, buildings, bridges, fields and meadows, national frontiers, parking facilities, service areas, built-up areas, traffic regulations, and speed limits.

Moreover, a route can be displayed in the form of a map representation on a landscape display unit of a route guidance device, for example a touch screen. This enables a user of the route guidance device to develop a spatial perception of the course of the route and to plan the manoeuvre in a forward-looking way.

A manoeuvre is meant to be a targeted motion realised by a movable object, such as an individual, a vehicle or a robot, in order to follow a route, for example a change in a direction of motion

A manoeuvre is computed by the computing unit of the route guidance device while taking into account a route, the current position, and the landscape data.

Moreover, a route guidance device can output a route guidance based upon a route to the user of the route guidance device. Is referred to as route guidance a process, which guides the user alongside the route. Using an output unit of the route guidance device, the route guidance outputs a manoeuvre instruction to the user. Such a manoeuvre instruction is a prompt aimed at the user to prepare or to execute a specific manoeuvre. In general, not only a manoeuvre instruction is attributed to a manoeuvre, but also a sequence of several manoeuvre instructions. Each of such manoeuvre instructions is output in a specific manoeuvre distance to a manoeuvre position, the manoeuvre position representing the position where the manoeuvre is to be executed. The manoeuvre distance can then variably be developed by a locomotion velocity of the object. The last manoeuvre instruction of the sequence prompts to immediately execute the manoeuvre while the previous manoeuvre instructions of the sequence only announce the manoeuvre and/or prepare the manoeuvre. A manoeuvre instruction can be output visually and/or acoustically to a user of a route guidance device.

Based upon a manoeuvre instruction, the manoeuvre can be executed by a movable object, such as by a user of the route guidance device.

In order to output a visual manoeuvre instruction, a route guidance device is provided with a manoeuvre display unit graphically representing the manoeuvre instructions, for example a directional arrow. For one vehicle, the manoeuvre display unit is typically arranged separately from the landscape display unit used to display a route in the form of a map representation.

In order to output an acoustic manoeuvre instruction, a route guidance device is provided with a voice output unit outputting the manoeuvre instructions in the voice form. Among others, the voice output unit has an audio amplifier and a loud speaker or several loud speakers. An acoustic manoeuvre instruction, such as in the form “Turn left in 200 meters” is also referred to as manoeuvre announcement.

The object of this present disclosure is to prepare a user of a route guidance device during a route guidance alongside a route for a manoeuvre in due time.

The object is achieved owing to a method of the present disclosure to output a manoeuvre instruction by means of a route guidance device. The method comprises the following steps:
Determining a route a movable object is to cover;
Determining a current position of the object on the route;
Determining of a manoeuvre position arranged on the route and where the object is to execute a manoeuvre in order to follow a route and, depending on the number of paths of paths which are arranged between the position of the object and the manoeuvre position alongside the route and/or a traffic density on the route between the position of the object and the manoeuvre position,
Determining an output position which is arranged between the position of the object and the manoeuvre position on the route;
Generating a manoeuvre instruction attributed to the output position, and
Outputting the manoeuvre instruction to a user of the route guidance device, as soon as the object reaches the output position.

The method takes into account the fact that the execution of a manoeuvre can be made more difficult where several paths are arranged alongside a route in the area of a manoeuvre position and/or where traffic is very dense. An exemplary situation enabling to advantageously apply the method is a situation where, due to an active route guidance by the route guidance device, a vehicle is to turn on a street having several traffic lanes. In this situation, the object is the vehicle, the manoeuvre to be executed is the turning action and the paths are the traffic lanes of the street. Often, a turning action from a multi-traffic lane street is only possible from a specific traffic lane or from a selection of specific traffic lanes, for example only from a traffic lane situated on the utmost right side, seen from the driving direction. Where the vehicle before turning is situated on another traffic lane, this situation can make such turning action more difficult or impossible, as a change in due time to the traffic lane on the utmost right side might be difficult or impossible due to high traffic density and/or a significant number of traffic lanes between the traffic lane currently used by the vehicle and the traffic lane on the utmost right side. In other word, there is a risk that the manoeuvre position might not be reached due to a too high locomotion velocity of the vehicle or to a too important traffic density on the street used by the vehicle from the position of the object.

Therefore, the method of the present disclosure provides for determining an output position where a manoeuvre instruction is output by means of a route guidance device, depending on the number of paths of paths which are arranged between the position of the object and the manoeuvre position alongside the route and/or a traffic density on the route between the position of the object and the manoeuvre position. Such manoeuvre instruction can inform the user of the route guidance device about the imminent manoeuvre and/or prepare him/her for the manoeuvre, for example by informing him/her in due time about the manoeuvre distance from the manoeuvre position, where the manoeuvre is to be executed and/or by recommending a change to a specific path in order to prepare the manoeuvre.

In one embodiment of the present disclosure, determination of the output position, generation of the manoeuvre instruction, and output of the manoeuvre instruction are executed when the number of paths of paths exceeds a number threshold value and/or the traffic density exceeds a traffic density threshold value. This embodiment of the present disclosure takes into account the fact that, in general, the execution of a manoeuvre is made significantly more difficult only when exceeding a specific path number and/or a specific traffic density such that the consideration of the path number and/or the traffic density when determining the output position, generating the manoeuvre instruction and outputting the manoeuvre instruction is advantageous only where the path number exceeds a number threshold value and/or the traffic density exceeds a traffic density threshold value.

In an alternative embodiment of the present disclosure of the aforementioned embodiment, the actions of determining the output position, generating the manoeuvre instruction and outputting the manoeuvre instruction are executed depending on a locomotion velocity at which the object is moved alongside the route. For example, the output position is determined, the manoeuvre instruction is generated, and the manoeuvre instruction is output where the path number of paths exceeds a number threshold value and the locomotion velocity falls below a lower velocity threshold value or the traffic density exceeds a traffic threshold value and the locomotion velocity exceeds an upper velocity threshold value. Thereby, the lower velocity threshold value and/or the upper velocity threshold value can depend on a class of the traffic route whereon the route takes course between the object position and the manoeuvre position, wherein a traffic route class can be a road category.

The aforementioned embodiments of the present disclosure take into account the fact that, due to the path number and/or the traffic density, the complication of the execution of a manoeuvre can significantly depend on the locomotion velocity of the motion of the object. Thus, a slow locomotion velocity of the object can be the expression of a status respectively a traffic jam risk on the route, thereby making a change to a specific path more difficult. Accordingly, where the number of paths of the object is high and the locomotion velocity of the object is low, a change in due time to this path can be necessary in order to execute the manoeuvre in the manoeuvre position. Likewise, a high traffic density combined with a high locomotion velocity of the object can make more difficult the change in due time to a specific path where the manoeuvre position is located, such that in this case, too, a corresponding output in due time of the manoeuvre instruction can be advantageous in order to prepare the manoeuvre. The requirement of a velocity threshold value depending on a class of a traffic route where the route takes course between the object position and the manoeuvre position takes into account the fact that a typical locomotion velocity of the object depends on a class of a traffic route. For example, the typical locomotion velocity on an arterial road is higher than the typical locomotion velocity on a country road such that, on an arterial road, a higher velocity threshold value is advantageously required than on a country road.

In another embodiment of the present disclosure, the manoeuvre instruction increases a number of manoeuvre instructions, which are attributed to the manoeuvre. This embodiment of the present disclosure makes it possible that a manoeuvre instruction is generated and output in addition to the manoeuvre instructions usually attributed to the manoeuvre. Thereby, one can advantageously generate and output a manoeuvre instruction specifically depending on the path number and/or the traffic density. Such an additional manoeuvre instruction can be formed as a recommendation for a change to a specific path, such as: “Please filter in the utmost left traffic lane”.

In another embodiment of the present disclosure, the manoeuvre instruction is output prior to the output of another manoeuvre instruction attributed to the manoeuvre. This embodiment of the present disclosure advantageously enables an output of the manoeuvre instruction in due time prior to the generation and output of the manoeuvre instructions usually attributed to the manoeuvre. A manoeuvre instruction preparing for the manoeuvre, for example a recommendation for a change to a specific traffic lane, can preferably be output prior to a manoeuvre instruction in order to execute the manoeuvre and prior to a manoeuvre instruction containing an information of a manoeuvre distance to the manoeuvre position.

In another embodiment of the present disclosure, the manoeuvre distance between the output position and the manoeuvre position increases with the path number of the paths and/or with the traffic density. This embodiment of the present disclosure advantageously takes into account the fact that the execution of the manoeuvre in the manoeuvre position is generally the more difficult the higher the path number and/or the higher the traffic density on the route between the position of the object and the manoeuvre position. Consequently, an output in due time of the manoeuvre instruction is ensured by the integration of a manoeuvre distance between the output position and the manoeuvre position increasing with the path number and/or the traffic density.

In another embodiment of the present disclosure, a path whereon the object is situated is taken into account when determining the output position. This embodiment of the present disclosure develops the aforementioned situation further insofar as the execution of the manoeuvre in the manoeuvre position is possible only on a specific path or a selection of specific paths. As a consequence, a change of the path is necessary where the object is situated on another path. A corresponding manoeuvre instruction to change the path can be generated and output depending on the number of the paths to be changed respectively to be crossed on the route between the object position and the manoeuvre position. Accordingly, any consideration of the path whereon the object is situated, is advantageous when determining the output position of the manoeuvre instruction in order to prepare the manoeuvre in due time.

Moreover, the object is achieved by means of a route guidance device having a position determination unit, a processing unit and an output unit. The position determination unit is configured to determine a current position of the object. The processing unit is configured to determine a route which a movable object is to cover, to determine a manoeuvre position arranged on the route, where the object is to execute a manoeuvre in order to follow the route and, depending on a number of paths of paths, which are arranged between the position of the object on the route and the manoeuvre position alongside the route, and/or a traffic density on the route between the position of the object and the manoeuvre position, to determine an output position which is arranged between the position of the object and the manoeuvre position on the route and to generate a manoeuvre instruction attributed to the output position, and The output unit is configured to output the manoeuvre instruction to a user of the route guidance device, as soon as the object reaches the output position. Such a route guidance device enables the realisation of the method of the present disclosure. Therefore, the advantages of such a route guidance device result from the aforementioned advantages of the method of the present disclosure.

Further embodiments of the present disclosure are described in more detail hereinafter by means of the drawings. Thereby:

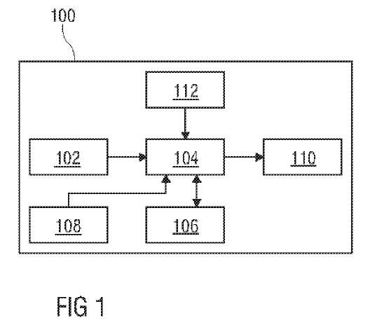

FIG. 1 shows a block diagram of a route guidance device according to one embodiment of the present disclosure,

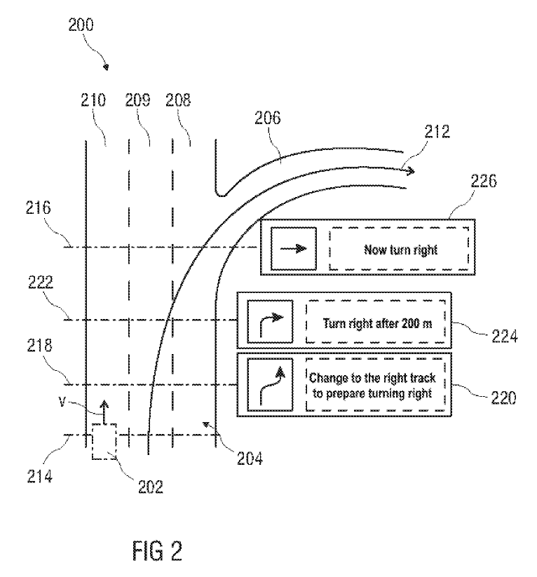

FIG. 2 shows a road network detail and several manoeuvre instructions according to one embodiment of the present disclosure, and

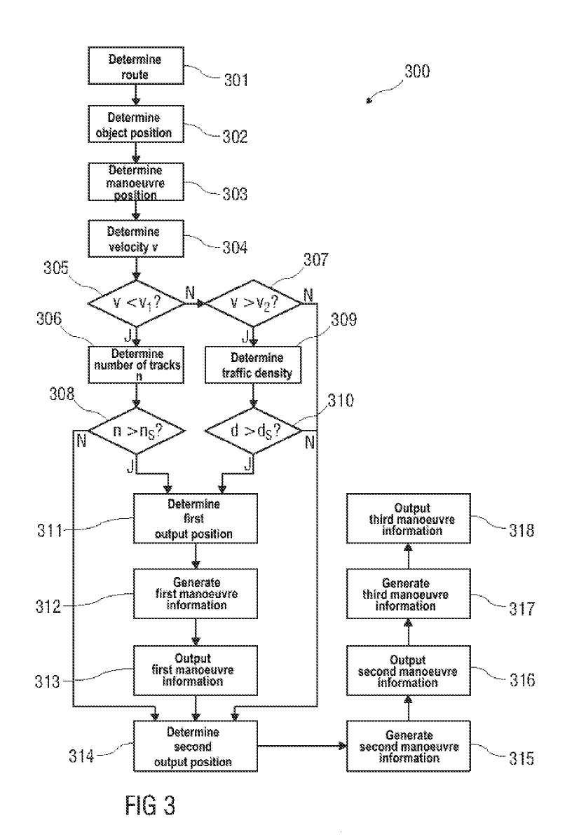

FIG. 3 shows a flow diagram of a method to output a manoeuvre instruction according to one embodiment of the present disclosure.

FIG. 1 shows a block diagram of a route navigation device 100 arranged in a vehicle (not shown). The route guidance device 100 features the following functional units illustrated in FIG. 1: one position determination unit 102, one processing unit 104, one storage unit 106, one control unit 108, one output unit 110, and one reception unit 112. Apart from the functional units shown herein, the route guidance device 100 can feature additional functional units not shown in FIG. 1, such as a communication unit designed for the data exchange with another device.

The position determination unit 102 is configured to determine a current position of the object of a movable object. The position determination unit 102 can for example be a GPS receptor, which is equipped with a satellite signal reception antenna in the form of a GPS antenna (not shown). Alternatively, a GALILEO receptor, a GLONASS receptor, or a similar receptor can be used instead of the GPS receptor. The position determination unit 102 can transfer position coordinates, which represent a geographic position of the object, extract these from satellite signals and transfer them to the processing unit 104. To this end, the position determination unit 102 is connected to the processing unit 104 via a unidirectional data circuit.

The processing unit 104 is the central control module of the route guidance device 100. Apart from a processor (CPU, Central Processing Unit), it features a random access memory (RAM, Random Access Memory) designed to store variables and interim results on a volatile basis. The processor and the random access memory are combined on an integrated circuit. Alternatively, the processor and the random access memory can be arranged separately, for example each one on another integrated circuit.

The processing unit 104 is configured, among others, to determine a route, which the object is to cover from a current position to a target position. To this effect, the processing unit 104 is able to convert a destination required by a user of the route guidance device 100 into a target position. Moreover, the processing unit 104 is configured to determine a manoeuvre position arranged on the route where the object is to execute a manoeuvre in order to follow the route to the target position.

Furthermore, the processing unit 104 is configured to determine an output position located on the route between the position of the object and the manoeuvre position. Thereby, the output position is determined depending on a path number of paths, which are arranged between the current position of the object on the route and the manoeuvre position alongside the route and/or a traffic density on the route between the position of the object and the manoeuvre position.

In addition, the processing unit 104 is configured to generate a manoeuvre instruction attributed to the output position.

The processing unit 106 features a non-volatile storage, which is formed for example as an EEPROM (Electrical Erasable Programmable Read-Only Memory).

Alternatively, the storage unit 106 can also feature a different storage type, such as a Flash-EEPROM or a hard disk. In particular, the storage unit 106 can have several of the aforementioned storages.

The storage unit 106 is connected to the processing unit 104 via a bidirectional data circuit. Among others, the storage unit 106 stores a landscape data base containing a multitude of landscape data. The landscape data represent objects, which are located in a specific geographic area. Such objects include for example streets, ways, squares, railroads, rivers, buildings, bridges, fields and meadows, national frontiers, service areas, traffic regulations, and built-up areas.

Apart from keys configured for control purposes, the control unit 108 features a voice entry unit and a touch screen. In addition or alternatively to one or several of said components, the control unit 108 can feature a rotation-press-actuator and/or a touch pad. The control unit 108 is connected to the processing unit 104 via a unidirectional data circuit and therefore is designed as a user interface of the route guidance device 100. Consequently, the user can set an operating command and/or a destination by means of the control unit 108 of the route guidance device 100.

The output unit 110 is configured to output the manoeuvre instruction to the user, as soon as the object reaches the output position. The output unit 110 is connected to the processing unit 104 via a unidirectional data circuit and among others provided to display a landscape map detail with the route. To this effect, the output unit 110 features a landscape display unit that is used as the touch sensitive screen of the control unit 108. The landscape detail can be illustrated as a top view similar to a street map or as a three-dimensional view.

The output unit 110 can be formed to output a visual manoeuvre instruction, such as in the form of a directional arrow to the user. To this end, the output unit 110 features a manoeuvre display unit, which is arranged separately from the landscape display unit. The manoeuvre display unit can feature, among others, a liquid crystal display (LCD), a display based upon electronic paper (E-Paper-Display), an organic light emitting diode (OLED) display or a projecting display (head-up-display). In another embodiment of the present disclosure, the landscape display unit and the manoeuvre display unit are combined in one module. Then, both units can feature a common monitor or a common projecting display.

Furthermore, the output unit 110 can be configured to output an acoustic manoeuvre instruction to the user. To this effect, the output unit 110 features a voice output unit having an audio amplifier and one or several loud speaker(s). Moreover, the audio amplifier and/or the loud speaker can be used to play a radio programme, such as a radio station, which is received by the reception unit 112.

The reception unit 112 is configured among others to receive traffic data. The reception unit 112 can be a radio reception unit which, apart from radio programmes, can receive traffic data in the form of RDS data (RAD=Radio Data System) or TMC data (TMC=Traffic Message Channel). In addition, the reception unit 112 can be able to receive respectively to send data by means of other communication connections and thereby to enable communication with other vehicles, road users or a surrounding infrastructure. The reception unit 112 is connected to a processing unit 104 via a unilateral data circuit transmitting data received to the processing unit 104 respectively data a be sent from the processing unit 104. In one alternative embodiment of the present disclosure, the reception unit is not integrated in the route guidance device but is an external device or integrated into an external device.

Hereinafter, reference is made to FIGS. 2 and 3. FIG. 2 shows a road network detail 200 as well as manoeuvre instructions 220, 224, 226 according to one embodiment of the present disclosure. FIG. 3 shows a flow diagram 300 of a method according to one embodiment of the present disclosure. The method is executed by using a route guidance device 100, which is described with reference to FIG. 1. The route guidance device 100 is arranged in a movable object 202 formed as a vehicle.

The road network detail 200 is shown on the landscape display unit of the output unit 110 of the route guidance device 100. The road network detail 200 represents a portion of the traffic route 204 used by the object 202 and which is a multi-lane street, in the area of a slip road 206 of the road. The road features several paths 208 to 210 arranged side by side between which the object 202 can change. The slip road 206 branches off from a first path 208. The object 202 features a locomotion velocity v, which is symbolised by means of an arrow in the motion direction of the object 202. Moreover, a route 212 is illustrated by means of an arrow.

In a first step of the method 301, the processing unit 104 is used to determine the route 212 leading from a current position of the route guidance device to a target position. To this effect, the user enters a destination in the route guidance device 100 by means of the control unit 108. Based upon the destination and by means of the processing unit 104 using the landscape data contained in the processing unit 106, the target position is determined. Alternatively, the target position can be determined on a predicative basis with reference to routes already covered. Moreover, and by means of the processing unit 104, the landscape data are used to determine the route 212 leading from the current position to the target position.

In an example illustrated in FIG. 2, the route 212 covers the traffic route 204 and the slip road 206.

In a second step of the method 302, the position determination unit 102 is used to determine a current position of the object 214 on the route 212.

In a third step of the method 303, a processing unit 104 is used to determine a manoeuvre position 216 arranged on the route 212 and where the object 202 is to execute a manoeuvre in order to follow the route 212. In the example shown in FIG. 2, the manoeuvre consists in leaving the traffic road 204 at the slip road 206 by turning right.

In a fourth step of the present disclosure 304, a temporary locomotion velocity v is determined, at which the object 202 is moved alongside the route 212. The locomotion velocity v is determined for example by means of the processing unit 104 using the position determination unit 102 from a multitude of previous positions of the object 202 and points in time at which the object 202 was located in such positions. Alternatively, or in addition, the locomotion velocity v is determined by using one or several sensors arranged in or on the object 202 and detecting the locomotion velocity v, for example via a revolution speed of a wheel or a drive shaft of the object 202.

In a fifth step of the method 305, the processing unit 104 is used to control whether the locomotion velocity v falls below a presettable lower velocity threshold value v₁. Should the locomotion velocity v fall below the lower velocity threshold value v₁, the method proceeds with a sixth step of the method 306. Otherwise, the method is continued with a seventh step of the method 307.

In the sixth step of the method 306, a processing unit 104 is used to determine a path number n of path numbers 208 to 2010 of the traffic road 204, which are arranged between the object position 214 and the manoeuvre position 216 alongside the route 212. The path number n can be determined by using the landscape data contained in the storage unit 106. Alternatively, or in addition, the path number n is determined by using one or several sensor(s) arranged in or on the object 202 and providing sensor data enabling the computation of the path number n. Such a sensor can be a camera shooting pictures of an environment of the object 202 wherefrom the path number n is determined using a processing unit 104 and by analysing the picture data.

In one eight step of the method 308 following the sixth step of the method 306, the processing unit 104 is used to examine whether the path number n exceeds a presettable number threshold value nₛ. Should the path number n exceed the number threshold value nₛ, the method proceeds with an eleventh step of the method 311. Otherwise, the method is continued with a fourteenth step of the method 314.

In a seventh step of the method 307, the processing unit 104 controls whether the locomotion velocity v exceeds a presettable upper velocity threshold value v₂. Should the locomotion velocity v exceed the upper velocity threshold value v₂, the method proceeds with a ninth step of the method 309. Otherwise, the method is continued with the fourteenth step of the method 314.

In the ninth step of the method 309, the processing unit 104 is used to determine a traffic density d on the route 212 between the position of the object 214 and the manoeuvre position 216. The traffic density is determined by means of traffic data which are received by the reception unit 112 and the transmitted to the processing unit 104. Alternatively, or in addition, the path number n is determined by using one or several sensor(s) arranged in or on the object 202 and providing sensor data enabling the computation of the traffic density d. Such a sensor can be a camera shooting pictures of an environment of the object 202 wherefrom the traffic density d is determined using a processing unit 104 and by analysing the picture data.

In one tenth step of the method 310 following the ninth step of the method 309, the processing unit 104 is used to examine whether the traffic density exceeds a presettable traffic density threshold value dₛ. Should the traffic density value d exceed the traffic density threshold value dₛ, the method proceeds with the eleventh step of the method 311. Otherwise, the method is continued with the fourteenth step of the method 314.

In the eleventh step of the method 311, the processing unit 104 is used to determine a first output position 218 for the output of the first manoeuvre instruction 220 in order to recommend to the user a change to the first path 208 as preparation for the manoeuvre.

In a step of the method 312 following the eleventh step of the method 311, the processing unit 104 is used to generate the first manoeuvre instruction 220.

In a thirteenth step of the method 313 following a twelfth step of the method 312, the output unit 110 is used to output the first manoeuvre instruction 220 to the user as soon as the object 202 reaches the first output position 218.

The first manoeuvre instruction 220 features a recommendation output visually and/or acoustically to change to the first path 208. The visually output recommendation is displayed on the manoeuvre display unit of the output unit 110 and can feature an arrow symbol that symbolises a path change. The acoustic recommendation output acoustically via the voice output unit of the output unit 110 is a manoeuvre announcement featuring for example the text “Change to the right path in order to prepare for turning right”.

Where the sixth step of the method 306 was executed, the output of the first manoeuvre instruction 220 is used to advantageously take into account the fact that a low locomotion velocity v of the object 202 can be indicative of a traffic congestion, such as a traffic jam or a traffic jam risk on the traffic road 204. A change to the first path 208 may be made more difficult by the traffic congestion such that in the event of a high path number n a change in due time to the first path 208 is necessary in order to execute the manoeuvre in the manoeuvre position 216. Where the ninth step of the method 309 was executed, the output of the first manoeuvre instruction 220 is used to advantageously take into account the fact that a high traffic density d on the traffic road 204 can make more difficult a change to the first path 208. Accordingly, and in the event of a high locomotion velocity v of the object 202, a change in due time to the first path 208 may be necessary in order to execute the manoeuvre in the manoeuvre position 216.

Therefore, in the eleventh step of the method 311, the first output position 218 is determined depending on the locomotion velocity v of the object 202 and/or, where the sixth step of the method 306 was executed, depending on the path number n or, where the ninth step of the method 309 was executed, depending on the traffic density d. Where the sixth step of the method 306 was executed, the first output position 218 is localised the farther away from the manoeuvre position 216, the lower the locomotion velocity v of the object 202 is and/or the higher the path number n is. Where the ninth step of the method 309 was executed, the first output position 218 is localised the farther away from the manoeuvre position 216 the lower the locomotion velocity v of the object 202 and/or the higher the traffic density d. Thereby, it is possible to advantageously recommend to the user a change to the first path 208 in due time in order to prepare the manoeuvre in the manoeuvre position 216 in the event of a traffic congestion on the traffic road 204 or in the event of a high traffic density d on the traffic road 204.

Following the thirteenth step of the method 313, the fourteenth step of the method 314 is executed.

In the fourteenth step of the method 314, the processing unit 104 is used to determine a second output position 222 for the output of a second manoeuvre instruction 224 in order to inform the user about the imminent manoeuvre. The second output position 222 is executed depending on the locomotion velocity v of the object 202 and/or where the sixth step of the method 306 was executed, depending on the path number n or, where the ninth step of the method 309 was executed, depending on the traffic density d. Where the sixth step of the method 306 was executed, the second output position 222 is localised the farther away from the manoeuvre position 216 the lower the locomotion velocity v of the object 202 and/or the higher the path number n. Where the ninth step of the method 309 was executed, the second output position 222 is localised the farther away from the manoeuvre position 216 the lower the locomotion velocity v of the object 202 and/or the higher the traffic density. Thereby, the user can advantageously be informed in due time about the imminent manoeuvre in the event of a traffic congestion on the traffic road 204 or in the event of a high traffic density d on the traffic road such that he/she can change to the first path 208 before reaching the manoeuvre position 216 on the first path 208, unless he/she has already done so.

In a fifteenth step of the method 315 following the fourteenth step of the method 314, the processing unit 104 is used to generate the second manoeuvre instruction 224.

In a sixteenth step of the method 316 following a fifteenth step of the method 315, the output unit 110 is used to output the second manoeuvre instruction 224 to the user as soon as the object 202 reaches the second output position 222.

The second manoeuvre instruction 224 features a visually and/or acoustically output information about the manoeuvre by outputting a type of the manoeuvre and a remaining manoeuvre distance to the manoeuvre position 216. The visually output information features an arrow symbol symbolising an imminent turning action to the right and is displayed on the manoeuvre display unit of the output unit 110. The information acoustically output via the voice output unit of the output unit 110 is a manoeuvre announcement featuring the text “Turn right in 200 meters”.

In a seventeenth step of the method 317, a third manoeuvre instruction 226 is generated in order to prompt the user to execute the manoeuvre in the manoeuvre position 216:

In an eighteenth step of the method 318 following a seventeenth step of the method 317, the third manoeuvre instruction 226 is output to the user as soon as the object 202 reaches the manoeuvre position 216.

The third manoeuvre instruction 226 features a visually and/or acoustically output prompt to execute the manoeuvre in the manoeuvre position 216. The visually output prompt features an arrow symbol symbolising a turning action to the right and is displayed on the manoeuvre display unit of the output unit 110. The prompt acoustically output via the voice output unit of the output unit 110 is a manoeuvre announcement featuring the text “Turn right now”.

Hereinafter are described alternative embodiments of the present disclosure, which are various variants of the method described above by means of FIG. 3.

In a first alternative embodiment of the method, the steps of the method 307, 309, and 310 are omitted. Instead and unless the locomotion velocity v falls below the lower velocity threshold value v₁, the step of the method 314 is executed following the step of the method 305 in this first alternative.

In a second alternative embodiment of the method, the steps of the method 305, 306, and 308 are omitted. In this second alternative, the step of the method 307 is executed following the step of the method 304 instead.

In a third alternative embodiment of the method, the steps of the method 304, 305, and 307 are omitted. Moreover, the steps of the method 306 and 309 as well as the steps of the method 308 and 310 are combined with each other. Consequently, the step of the method 311 is executed where both the path number n exceeds the number threshold value nₛ or the traffic density d exceeds the traffic density threshold value dₛ, otherwise, the step of the method 314 is executed.

In a fourth alternative embodiment of the method, the steps of the method 304 to 308 are omitted. In this fourth alternative, the step of the method 309 is executed following the step of the method 303 instead.

In a fifth alternative embodiment of the method, the steps of the method 304, 305, 307, 309, and 310 are omitted. In this fifth alternative, the step of the method 306 is executed following the step of the method 303 instead.

Other alternative embodiments of the method result from the aforementioned embodiments.

For example, when determining the first output position 218 in the step of the method 311 and/or when determining the second output position 222 in the step of the method 314, one can determine and take into account a path 208 to 210 whereon the object 202 is located. It is in particular possible to provide that the manoeuvre distance of the first output position 218 and/or the second output position 222 relative to the manoeuvre position 216 increases with the number of paths 208 to 210, which are located between the first path 208 and the paths 208 to 210 whereon the object 202 is located. Should it be determined that the object 202 is already located on the first path 208, it is moreover possible to completely omit the generation and the output of the first manoeuvre instruction 220 such that the steps of the method 312 and 313 are not executed. Alternatively, a recommendation to remain on the first path 208 can be output as first manoeuvre instruction 220.

In addition, or alternatively, the lower velocity threshold value v₁ in the step of the method 305 and/or the upper velocity threshold value v₂ in the step of the method 307 can depend on a class of the traffic road 204. Accordingly, a traffic road 204 executed as an arterial road can have another lower velocity threshold value v₁ and/or another upper velocity threshold value v₂ than a traffic road 204 executed as a road inside built-up areas. The class of the traffic road 204 can be determined by means of the processing unit 104 and by using the landscape data contained in the storage unit 106. Alternatively, the class of the traffic road can be determined by analysing picture data, for example from a picture of a traffic sign located in the proximity of the object.

1. A method for outputting a manoeuvre instruction by means of a route guidance device having the following steps:
determining a route a movable object is to cover;
determining a current position of the object on the route;
determining of a manoeuvre position arranged on the route and where the object is to execute a manoeuvre in order to follow a route and, depending on the number of paths (n) of paths which are arranged between the position of the object and the manoeuvre position alongside the route or a traffic density (d) on the route between the position of the object and the manoeuvre position;
determining an output position which is arranged between the position of the object and the manoeuvre position on the route;
generating a manoeuvre instruction attributed to the output position; and
outputting the manoeuvre instruction to a user of the route guidance device, as soon as the object reaches the output position.

2. The method according to claim 1, where the determination of the output position, the generation of the manoeuvre instruction and the output of the manoeuvre instruction are realised when the number of paths (n) exceeds a number threshold value (n₂) and/or where the traffic density (d) exceeds a traffic density threshold value (dₛ).

3. The method according to claim 1, where the determination of the output position, the generation of the manoeuvre instruction, and the output of the manoeuvre instruction are realised depending on a locomotion velocity (v) by which the object is moved alongside the route.

4. The method according to claim 3, where the output position is determined, the manoeuvre instruction is generated and the manoeuvre instruction is output, when the number of paths (n) exceeds a number threshold value (n₂) and the locomotion velocity (v) falls short of a lower velocity threshold value (v₁) or the traffic density (d) exceeds a traffic density threshold value (d₂) and the locomotion velocity (v) exceeds an upper velocity threshold value (v₂).

5. The method according to claim 4, where the lower velocity threshold value (v₁) and/or the upper velocity threshold value (v₂) depend on a class of a traffic route on which passes the route between the object and the manoeuvre position.

6. The method according to claim 1, where the manoeuvre instruction increases a number of manoeuvre instructions which are attributed to the manoeuvre.

7. The method according to claim 1, where the manoeuvre instruction is output before another manoeuvre instruction attributed to the manoeuvre is output.

8. The method according to claim 1, where a manoeuvre distance between the output position and the manoeuvre position increase with the number of paths (n) or the traffic density (d).

9. The method according to claim 1, where during the determination of the output position a path is taken into account on which the object is arranged.

10. A route guidance device comprising:
a position determiner which is configured to determine the position of the object;
a processing circuitry which is configured to determine a route which a movable object is to cover, to determine a manoeuvre position arranged on the route, where the object is to execute a manoeuvre in order to follow the route and, depending on a number of paths (n) of paths, which are arranged between a current position of the object on the route and the manoeuvre position alongside the route, and/or a traffic density (d) on the route between the position of the object and the manoeuvre position, to determine an output position which is arranged between the position of the object and the manoeuvre position on the route and to generate a manoeuvre instruction attributed to the output position; and
an output which is configured to output the manoeuvre instruction to a user of the route guidance device, as soon as the object reaches the output position.
